(19) United States
(12) Patent Application Publication
(10) Pub. No.: US 2005/0170895 A1
(43) Pub. Date: Aug. 4, 2005

(54) Adjustable monitor assembly

(76) Inventors: Kurt Businger, Warwick, RI (US); Laurence Tremaine, Warwick, RI (US); Michael Paloian, Cold Spring Harbor, NY (US)

Correspondence Address: Andrew L. Reibman, Esq.;KENYON & KENYON, One Broadway, New York, NY, 10004, US

(21) Appl. No.: 10/769,368

(22) Filed: Jan. 30, 2004

(51) Int. Cl. A63F 13/00

(52) U.S. Cl. 463/47

(57) ABSTRACT

An adjustable monitor assembly configured to adjustably secure a monitor to a support structure or a gaming terminal and a method for adjusting the monitor support adjustable monitor assembly is disclosed.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

A gaming terminal may be formed as a structure similar to a cabinet. The interior of the gaming terminal may include a monitor support to hold a monitor. The gaming terminal may include several parts, such as hinged doors, locks, many pieces of small hardware, and compartments. The compartments may be used to house different electronic components. The gaming terminals are often locked for security reasons, so that access to the interior is limited to personnel possessing, for example, keys or knowledge of security codes. A hinged door, for example, may form the front of the gaming terminal. The hinged door may have one or more apertures in the form of cutouts, slots, and/or windows. Some of the interior components may be accessible through these apertures. The gaming terminal houses the electronic devices, such as the monitor, processor, ticket printers, cables and bus connectors, fans, currency distributing and collecting devices, LEDs, etc.

In some gaming terminals, there may be gaps between the outer and interior components, such as between the door and the monitor. These gaps may allow dust and contaminates to enter the gaming terminal. Existing gaming terminals may not allow for adjustment of the monitor to eliminate these gaps or correct the alignment of the monitor within the gaming terminal.

### BRIEF DESCRIPTION OF THE DRAWINGS

FIG. 1 illustrates an example gaming terminal, according to an example embodiment of the present invention.

FIG. 2 illustrates an example arrangement of the interior of a gaming terminal, according to an example embodiment of the present invention.

FIG. 3 illustrates example jack screw assembly pieces, according to an example embodiment of the present invention.

FIG. 4A illustrates a partially installed jack screw assembly, according to an example embodiment of the present invention.

FIG. 4B illustrates an example installed jack screw assembly, according to an example embodiment of the present invention.

FIG. 5 illustrates an exemplary embodiment of an adjustable monitor assembly, according to an example embodiment of the present invention.

FIG. 6 illustrates an example method for securing a monitor to a gaming terminal chassis according to an example embodiment of the present invention.

### DETAILED DESCRIPTION OF EXAMPLE EMBODIMENTS

It will be appreciated that where an identical feature is presented in different figures, the same reference numeral is used to indicate the identical feature in each of the figures.

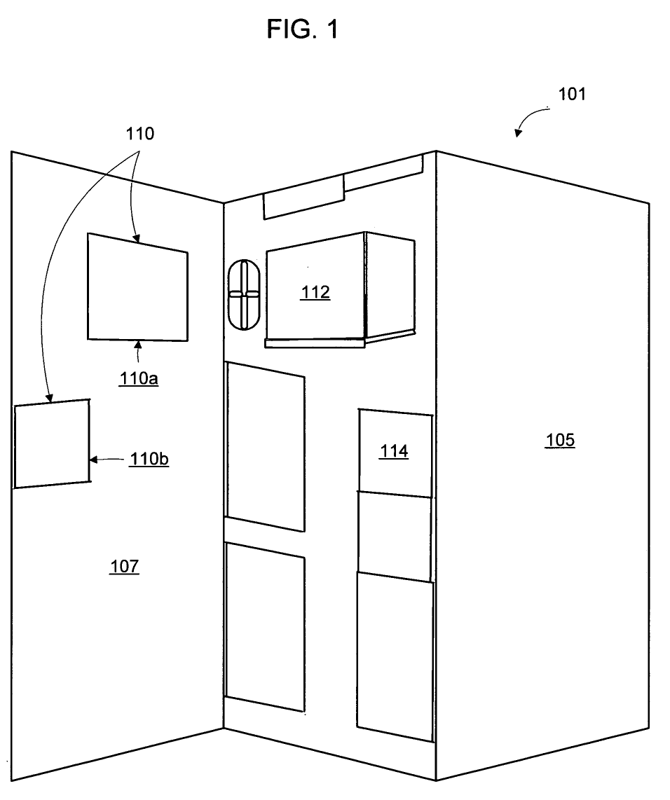

FIG. 1 illustrates an example gaming terminal, according to an example embodiment of the present invention. The example gaming terminal 101 may include a housing 105 and a door 107. The door 107 may be hinged to the housing 105, and may open to provide access to the components housed in the interior of the housing 105. The door 107 may have apertures 110, through which some of the interior components are visible or accessible when the door 107 is in a closed position. It will be appreciated that apertures 110 may be formed, for example, as open apertures, apertures covered with transparent or opaque covers, apertures with hinged or rotatable covers or slots. It will be appreciated that various kinds and arrangements of apertures are contemplated, for example, printer slots, coin deposit and return slots, card readers slots, etc. For example, in FIG. 1, two apertures 110 are shown in door 107. One aperture 110a allows monitor 112 to be viewed and another aperture 110b allows a card reader 114 to be accessed when the door 107 is in the closed position.

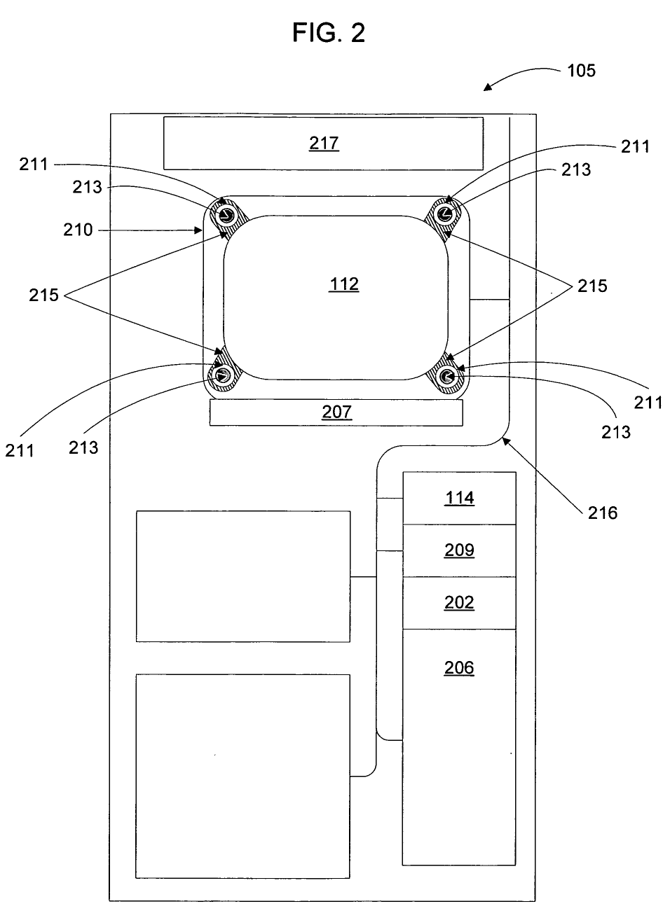

FIG. 2 illustrates an example arrangement of the interior of a gaming terminal, according to an example embodiment of the present invention. Housing 105 is shown, as well as various electronic components which may be housed in the interior of housing 105.

For example, a monitor 112, is shown. The monitor 112 may be placed in the interior of a chassis 210. The chassis 210 may be supported by a tray 207. The tray 207 may be attached to the interior walls of the housing 105. It will be appreciated that other arrangements are contemplated, for example, the chassis 210 itself may be secured to one or more of the inner walls of the housing 105, or the chassis 210 and/or tray 207 may be built into the housing 105 during fabrication of the walls. The chassis 210 may have apertures 211, for example, screw holes, into which jack screw assemblies 213 may be inserted in order to secure the monitor 112 to the chassis 210. In this regard, the monitor may have retainers 215 with apertures, e.g., screw holes, through which jack screw assemblies 213 may be passed.

A guard plate 217, made of for example, aluminum or steel, may be placed above the monitor 112, as shown in FIG. 2. A processor 206, for example, a CPU or other suitable device, may be housed in the housing 105. The processor 206 may, for example, run the software necessary for the gaming terminal to operate. A ticket and/or receipt printer/dispenser 202 may be housed in the housing 105. A currency distributing and collecting device 209 may be housed in the housing 105. A card reader 114, for reading gaming, credit, and/or debit cards may be housed in the housing 105. Electric cables 216 may be housed in the housing 105. It will be appreciated that other components may be included in the gaming terminal, as are necessary to operate the gaming terminal.

The jack screw assemblies 213 may be used to secure the monitor 112 to the chassis 210. In contrast to conventional screws, which hold the monitor 112 only in a particular position, the position of the monitor 112 may be adjusted after the jack screw assemblies 213 are tightened.

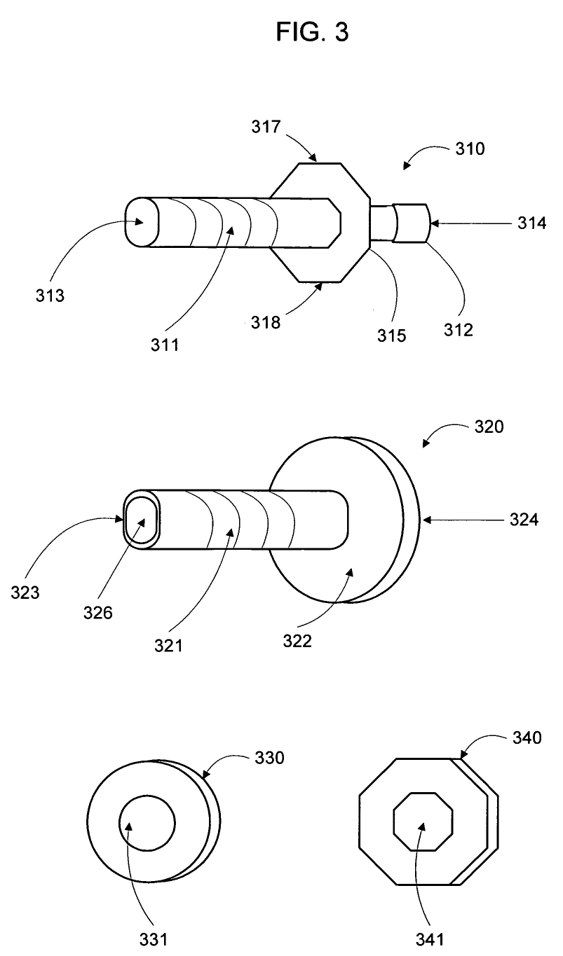

FIG. 3 illustrates example jack screw assembly pieces 310, 320, 330, 340, according to an example embodiment of the present invention.

Jack stud 310 may include a shaft 311. The shaft 311 may have a head 312 at one of two ends 313 and 314. The shaft 311 may also have a shoulder 315. The shoulder 315 may be located, for example, close to head 312. The shoulder 315 may be formed with a circular circumference, or a polygonal circumference. The shaft 311 may be externally threaded. The shaft 311 may be any length necessary to accommodate the parts it will need to hold to secure the monitor to the chassis. For example, an M5 jack stud may be used. It will be appreciated that any variety of screw or bolt may be used to form the jack stud 310, such as a flat head, pan head, washer head, oval head, hex head, round head, fillister head, or phillips head or combination head. Alternatively a dowel or an anchor may be used.

The exemplary jack stud shown in FIG. 3 includes a shaft 311 that is about 26 mm in length. The diameter of the shaft is about 4 mm. Head 312 is about 4 mm long. Shoulder 315 is located about 4 mm from head 312. The shoulder 311 has a polygonal circumference with opposite edges 317, 318 about 10 mm apart. The shoulder is about 2 mm long. The external threading is provided between end 313 and to within 2 mm of the shoulder 315. It may be appreciated that jack studs having different measurements may be used, and that these measurements are only exemplary.

Jack screw 320 may include a hollow shaft 321. The shaft may have a shoulder 322 at one of two ends 323 and 324. The jack screw 320 may be internally threaded to match with the external threads of the jack stud 310. The jack screw 320 may be externally threaded. The jack screw 320 may include a longitudinal inner bore 326 having a size just large enough to accommodate jack stud 310.

The exemplary jack screw shown in FIG. 3 includes a shaft 321 that is about 20 mm in length. The diameter of inner bore 326 about 4 mm. The diameter of the outside of shaft 321 is about 7 mm. Shoulder 322 has circular circumference. Shoulder 322 has a diameter of about 18 mm. Shoulder 322 is about 4 mm long. The external threading is provided between end 323 to within about 2 mm of the shoulder 322. It may be appreciated that jack screws having different measurements may be used and that these measurements are only exemplary.

Washer 330 and nut 340 may be conventionally constructed and have dimensions such that they will securely fit on jack screw 320. According to the exemplary washer 330 shown in FIG. 3, the radius of the aperture 331 of the washer 330 is about 7 mm. According to the exemplary nut 340 shown in FIG. 3, the radius of the aperture 341 of the nut 340 is about 7 mm. It may be appreciated that washers and nuts having different measurements may be used and that these measurements are only exemplary.

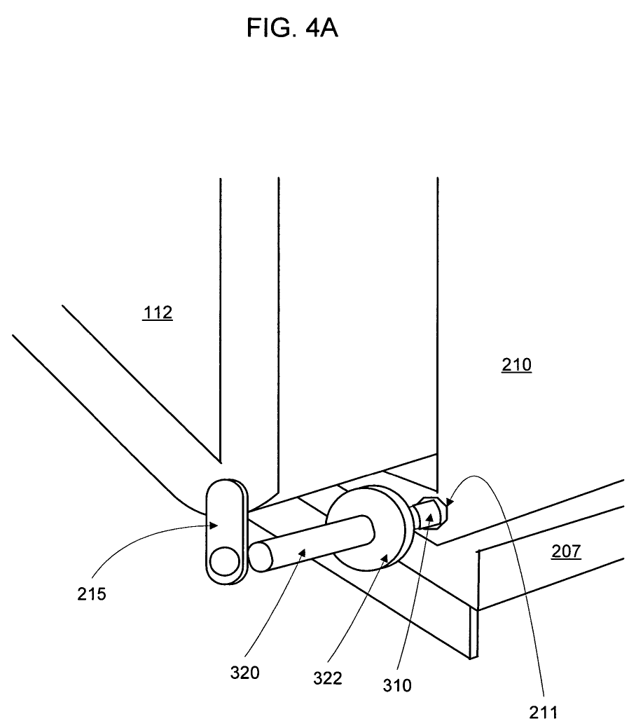

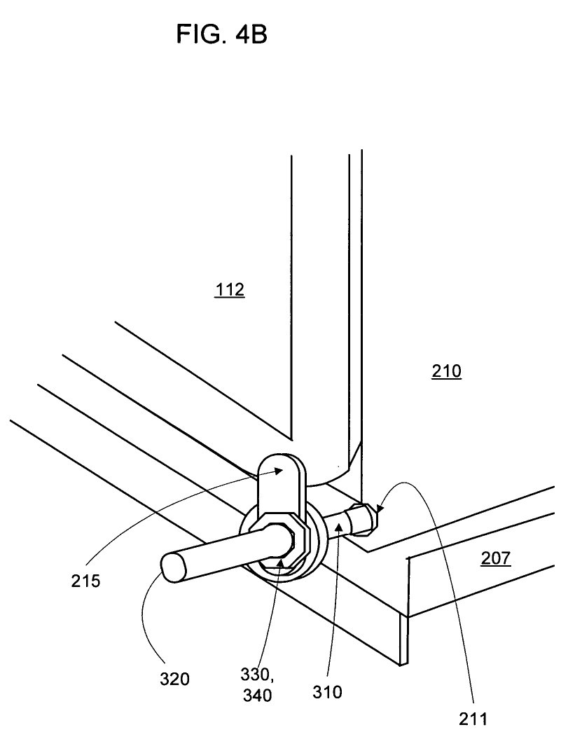

FIG. 4A illustrates a partially installed jack screw assembly, according to an example embodiment of the present invention. The jack screw assembly may be used to secure the monitor 112 to the chassis 210. The chassis 210 may be supported by a tray 207. The chassis may have at least one aperture 211, for example, four screw holes, however only one aperture 211 is shown in the Figure. A jack stud 310 is first secured in aperture 211. The head of the jack stud 310 is secured in the aperture 211. The jack screw 320 may then be threaded onto the jack stud 310 until the shoulder 322 of the jack screw 320 reaches the chassis 210. A retainer 215 is shown extending from the monitor 112. The retainer 215 has an aperture which allows it to be placed over the jack screw 320.

FIG. 4B illustrates an example installed jack screw assembly, according to an example embodiment of the present invention. The retainer 215 of the monitor 112 has been placed onto the jack screw 320 and one washer 331 and one nut 341 has been loosely placed onto the jack screw 320 over the retainer 215. Before a final tightening of the washer 330 and/or nut 340, the jack screw assembly pieces may be similarly placed in any other retainers 215 of the monitor 112. For example a total of four jack screw assemblies may be put in place, one in each of the four corners of the monitor 112.

Several measures may be taken to properly position the monitor using the jack screw assemblies. The gaming terminal door may be partially closed so that positioning of the monitor may be observed. While the door is closed, a distance between the monitor and the door may be measured. If an undesirably large gap is observed, one or more of the jack screws may be adjusted, for example, by turning the jack screw in a direction opposite the direction in which it was threaded onto the jack stud. This would move the monitor in a forward direction. Accordingly, the jack screws may be adjusted until the gap observed between the monitor and the door is desirably small or is eliminated. Therefore, these exemplary embodiments of the present invention provide for more accurate alignment of the monitor within the housing, thereby minimizing any gaps between the monitor and the housing. These gaps may allow dust and contaminates to collect inside the gaming terminal. Furthermore, the gaps may pose a security risk because it may be possible to forcibly open a locked gaming terminal, or in some way damage the gaming terminal, by inserting an instrument, for example, into the gaps.

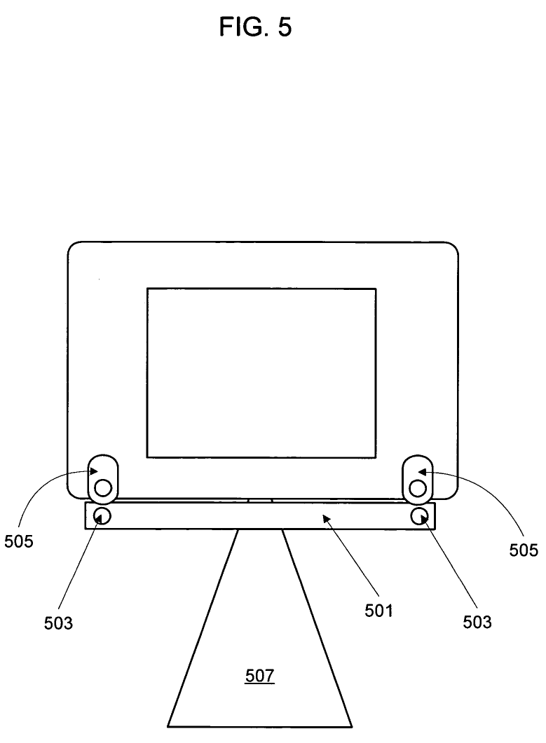

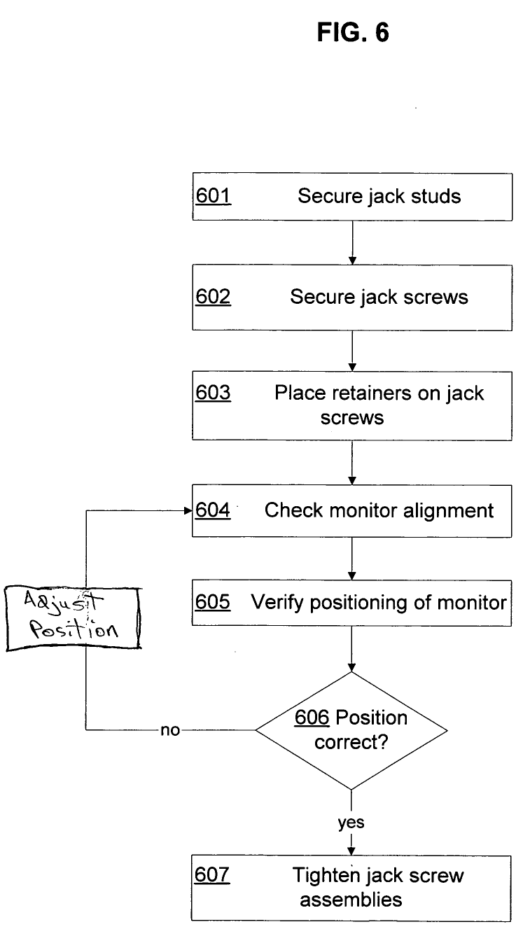

The jack screw assemblies may be applied to other types of monitor supports which are not enclosed in a gaming terminal. FIG. 5 illustrates an exemplary embodiment of an adjustable monitor support including jack screw assemblies, according to an example embodiment of the present invention. The adjustable monitor support shown in FIG. 5 may be coupled to other structures, such as cabinets, desks, and other furniture. The adjustable monitor support may be mounted, for example, to a wall or other support structure. A ledge 501 is provided. The ledge 501 may have apertures 503 to accommodate the jack studs. A base 507 or other additional support structure may be provided to give additional support to the ledge 501. Retainers 505 with apertures are applied to the monitor, or may be manufactured as part of the monitor. In the manner of the method illustrated in FIG. 6, the jack studs may be inserted into the apertures 503 in the base 507. The jack screws may be placed over the jack studs. The retainers 505 of the monitor may be placed over the jack screws and washers and/or nuts may be used to tighten the jack screws into place.

In another exemplary embodiment, where a structure is provided to support the monitor, an adjustable insert for securing the monitor to the structure may be provided at one or more points. The insert or inserts may be arranged to be separately adjustable at each of the points where an insert is located.

FIG. 6 illustrates an example method for securing a monitor to a gaming terminal chassis according to an example embodiment of the present invention

At 601 the jack studs are secured in place. It will be appreciated that the jack studs may be placed one or more at a time. The chassis may be tilted or otherwise modified in positioning to facilitate inserting the jack studs. A wrench or other conventional tool may be used to secure the jack studs. It may also be appreciated that the monitor may be disconnected while installing the jack screw assemblies. Additionally, some other components, including wires, cables, and connectors, may need to be tied, or fixedly held so as not to interfere with proper installation of the jack screw assemblies and positioning of the monitor.

At 602, the jack screws are placed over the jack studs. It will be appreciated that additional washers, or other spacing devices, may be added between any of the jack screw assembly components for better positioning.

At 603, the retainers may be placed on the jack screws, and additional washers and/or nuts may be loosely placed over the retainers. It will be appreciated that any numbers of jack screw assemblies may be used. It will also be appreciated that other pieces having apertures to accommodate screws, such as pieces located in places other than the corners of the monitor, may be used.

At 604, the alignment of the monitor may be evaluated. For example, in the case of the gaming terminal 101, measurements of the gap between the monitor and the gaming terminal door may be taken. For example, the measurement of this gap may be taken and compared to a predetermined value. If the measured value is greater than the predetermined value, the jack screws may be adjusted by turning them in the direction opposite the direction in which they were threaded onto the jack studs, thereby at least partially closing the gap.

For example, the predetermined value for the gap between the monitor and the terminal door may be 3 mm. The measured value of the gap may be, for example, 5.5 mm. Therefore, the jack screws may be backed out 2.5 mm to reduce the gap to 3 mm. If the pitch of the screw threading of the jack screw equals, for example 0.5 mm, then the screw may be backed out 5 turns in order to reduce the gap to 3 mm. It will be appreciated that jack screws having different threading pitches may be used and that these measurements are only exemplary.

At 605, the final positioning may be verified to be as desired, and the jack screws may be secured by tightening the washers and/or nuts.

At 606, if the positioning is not correct, more adjustments may be made until the position has been sufficiently corrected.

At 607 a final tightening of the jack screw assemblies may be accomplished by securing the washer and/or nut in place.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. An adjustable monitor support comprising:
a support structure configured to support a monitor; and
a plurality of jack screw assemblies configured to adjustably secure the monitor to the support structure.

2. The adjustable monitor support of claim 1, wherein each of the plurality of jack screw assemblies includes:
a jack stud configured to be fixedly inserted into a hole in the support structure;
a jack screw configured to be threaded onto the jack stud; and
a nut configured to be threaded onto the jack screw.

3. The adjustable monitor support of claim 2, wherein the monitor includes a retainer, having an aperture, configured to be disposed on the jack screw.

4. The adjustable monitor support of claim 3, wherein the nut is configured to be disposed on the jack screw and over the retainer.

5. The adjustable monitor support of claim 2, wherein the jack screw is configured to be rotated relative to the jack stud, wherein a position of the monitor changes with a change in position of the jack screw.

6. A gaming terminal comprising:
a monitor;
a housing; and
a plurality of jack screw assemblies configured to adjustably secure the monitor to the housing.

7. The gaming terminal of claim 6, wherein each of the plurality of jack screw assemblies includes
a jack stud configured to be fixedly inserted into an aperture in the housing;
a jack screw configured to be threaded onto the jack stud; and
a nut configured to be threaded onto the jack screw.

8. The gaming terminal of claim 7, wherein the monitor includes at least one retainer having an aperture configured to accommodate the jack screw.

9. The gaming terminal of claim 7, wherein the jack screw is configured to be rotated until an evaluated position of the monitor matches a predetermined position of the monitor.

10. The gaming terminal of claim 9, wherein a value representing the predetermined position of the monitor matches a distance between a front door of the gaming terminal and the monitor, when the front door of the gaming terminal is in a closed position.

11. The gaming terminal of claim 10, wherein the value representing the predetermined position of the monitor is between 2 mm and 5 mm.

12. The gaming terminal of claim 7, wherein the jack screw has a pitch measuring 0.5 mm.

13. The gaming terminal of claim 7, further comprising:
a processor, a printing device, and a currency distributing and collecting device disposed in the housing.

14. An adjustable monitor support comprising:
a structure configured to support the monitor;
means for securing the monitor to the structure at at least one point, wherein the means is configured to be separately adjustable at each of the at least one points.

15. A gaming terminal, comprising:
a monitor;
a housing; and
means for adjustably securing the monitor to the housing at at least one point, wherein the means is configured to be separately, mechanically adjustable at each of the at least one points.

16. A method for adjusting the position of a monitor, comprising:
supporting a monitor via a support structure; and
adjustably securing the monitor to the support structure via a plurality of jack screw assemblies.

17. The method of claim 16, further comprising:
fixedly inserting a jack stud into an aperture in the support structure;
threading a jack screw onto the jack stud; and
threading a nut onto the jack screw.

18. The method of claim 17, further comprising:
placing a retainer onto the jack screw, wherein the retainer extends from the monitor and includes an aperture configured to accommodate the jack screw.

19. The method of claim 17, further comprising:
evaluating a position of the monitor relative to a predetermined position of the monitor; and
rotating at least one jack screw until the evaluated position of the monitor matches the predetermined position of the monitor.

20. A method for adjusting the position of a gaming terminal monitor comprising:
securing a monitor to a housing of the gaming terminal via at least one jack screw assembly; and
adjusting a position of the monitor via the at least one jack screw assembly.

21. The method of claim 20, further comprising:
fixedly inserting a jack stud into an aperture in the support structure;
threading a jack screw onto the jack stud; and
threading a nut onto the jack screw.

22. The method of claim 21, further comprising:
adjusting a position of the monitor after the monitor is secured to the housing by rotating the jack screw relative to the jack stud.

23. The method of claim 22, further comprising:
evaluating the position of the monitor relative to a predetermined position of the monitor; and
rotating at least one jack screw until the evaluated position of the monitor matches the predetermined position of the monitor.

24. The method of claim 23, wherein a value representing the predetermined position of the monitor is equal to the distance between a front door of the gaming terminal and the monitor, when the front door of the gaming terminal is in a closed position.

25. The method of claim 24, wherein value representing the predetermined position of the monitor is between 2 mm and 5 mm.

26. The method of claim 21, wherein the jack screw has a pitch measuring 0.5 mm.
